(19) United States
(12) Patent Application Publication
(10) Pub. No.: US 2023/0414447 A1
(43) Pub. Date: Dec. 28, 2023

(54) Liquid Tongue

(71) Applicant: Gary Troy Demola, Madisonville, LA (US)

(72) Inventor: Gary Troy Demola, Madisonville, LA (US)

(21) Appl. No.: 18/125,544

(22) Filed: Mar. 23, 2023

Related U.S. Application Data
(60) Provisional application No. 63/355,055, filed on Jun. 23, 2022.

(51) Int. Cl. A61H 19/00

(52) U.S. Cl. CPC A61H 19/30; A61H 2201/01

(57) ABSTRACT

Disclosed is a sex toy with a small/micro water pump enclose in one casing to pump water through to small stream or streams of water spray where the stream(s) can be moved by hand to point at erogenous areas and stream(s) can be position stationary to stay focus on the part of erogenous area of the body wanting stimulated. The small stream or streams of water spray can be positioned to point at erogenous areas of a person in different positions whether lying down, kneeling, squatting or standing. In lying down, kneeling, or squatting position it would be possible for average person with moderate flexibility and dexterity to move the stream(s) by hand around the erogenous area pointed at while being stimulated by stream(s) of water instead of just using a stationary stream(s) position(s). Another casing holds the battery compartment and on/off switch for powering and turning on and off. There is a long enough electrical wire running from each casing to allow user to turn on and off easier from body position. The configuration of the sex toy makes it easier to allow body to be in different positions while being stimulated. The smaller stream or streams of water spray provide a very pleasing size and strength and stream strength may be adjusted by user further by manual valves. There may also be adjustable spray nozzles at the end of water spray stream to provide different stimulating effects by the way they spray.

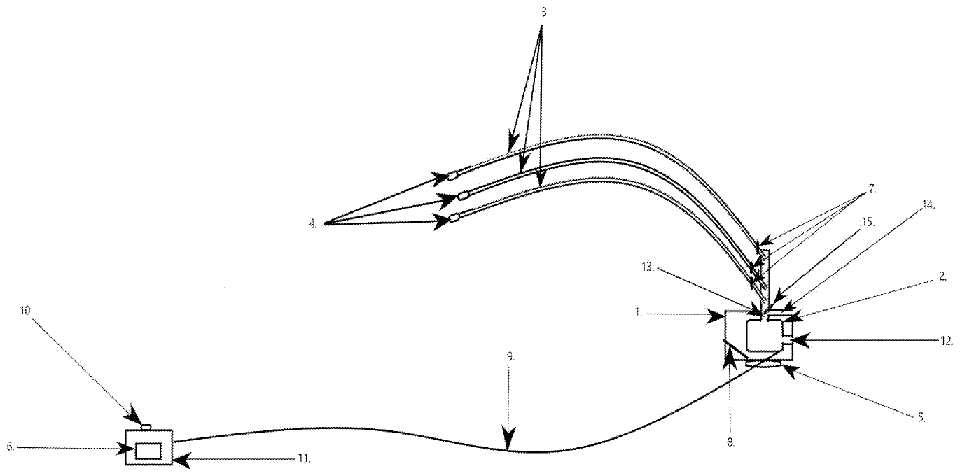

### BACKGROUND OF INVENTION

The present invention relates generally to sex toys. More particularly the present invention relates to a sex toy that uses a small stream or streams of water spray where the stream(s) can be moved by hand to point at erogenous areas and stream(s) can be position stationary to stay focus on the part of erogenous area of the body wanting stimulated by stream(s). The small stream or streams of water spray can be positioned to point at erogenous areas of a person in different positions whether lying down, kneeling, squatting or standing. In lying down, kneeling, or squatting position it would be possible for average person with moderate flexibility and dexterity to move the stream(s) by hand around the erogenous area pointed at while being stimulated by stream(s) of water instead of just using a stationary stream(s) position(s) during stimulation.

Throughout history human beings have used artificial means to stimulate sexually to help meet sexual gratifications needs. Some examples being vibrators, massagers, and tongue devices to simulate oral gratification that are used to stimulate an erogenous area of body. This present device uses a small stream or streams of water spray to give that kind of combine experience of micro tingling vibration from water bouncing off area, massaging, and feeling of oral stimulation to erogenous areas whether it be male or female.

Typically shower heads, handheld shower heads and other similar products are not made by design for sexually stimulation in mind. Even though they can be used in some cases to stimulate sexually they may be difficult to get position to focus on erogenous area, may be difficult to control water pressures and may be too strong or weak, may not give the right kind of focus stream of water looking for in stimulation since they were never made for purpose of sexual gratifications in mind.

Accordingly, there is a need for a sex toy that is design to use a small stream or streams of water spray for purpose of sexual gratification as described above. The present invention fulfills these needs and provides other related advantages.

### SUMMARY OF INVENTION

The present invention is directed to a sex toy comprising of a small/micro water pump and small stream or streams of water spray where the stream(s) can be moved by hand to point at erogenous areas and stream(s) can be position stationary to stay focus on the part of erogenous area of the body wanting stimulated by stream(s).

The small stream or streams of water spray can be positioned to point at erogenous areas of a person in different positions whether lying down, kneeling, squatting or standing.

In lying down, kneeling, or squatting position it would be possible for average person with moderate flexibility and dexterity to move the stream(s) by hand around the erogenous area pointed at while being stimulated by stream(s) of water instead of just using a stationary stream(s) position(s) during stimulation.

The present invention would be used in a shallow contain water area like a tub which would allow enough water to stay covered over the small/micro water pump which will be pumping water through to the small stream or streams of water spray when turn on.

The present invention will need to stay stationary and use a suction cup at bottom of device to hold it secure to bottom surface of a tub or some other surface it can adhere to.

The present invention will power water pump by a battery when on/off switch is turned on.

The present invention has a manual valve by diverter outlet pipe and manual valve on each small stream of water spray. The manual valve by diverter outlet pipe when valve is in more open position will lessen the amount of water going to stream or streams of water spray by diverting water to diverter outlet pipe and more close position will allow more water to flow to stream or streams of water spray. The manual valve on each small stream of water spray will control the amount of water flowing through each respectively depending on how open or close valve position is. This will give the user more ways to control the overall effect of water pressure on each stream of water when spraying on erogenous area.

The present invention may have adjustable spray nozzles at end of small stream or streams of water to give different spray effects.

Other features and advantages of the present invention will become apparent from the following more detailed description, taken in conjunction with the accompanying drawing, which illustrates the principles of the invention.

### BRIEF DESCRIPTION OF THE DRAWINGS

A perspective view of what sex toy might look like according to the present invention if had three water stream sprayers.

### DETAILED DESCRIPTION OF THE INVENTION

Casing of plastic 1 holds small/micro water pump 2, inlet pipe 12 goes inside casing to take in water to small/micro water pump 2, outlet pipe 13 where water pumps out from small/micro water pump 2 and runs by a manual valve 15 by diverter outlet pipe 14 and then certain amount of water will then continue thru rest of outlet pipe 13 and diverter outlet pipe 14 depending on the manual valve 15 valve position, any water not diverted continues thru the rest of outlet pipe 13 runs by a manual valve 7 on each small stream or streams of water 3 and depending on the manual valve 7 valve position on each corresponding small stream or streams of water 3 control amount of water that flows thru the corresponding stream it is on and then on thru to a spray nozzle 4 at end of each stream, manual valve 15 by diverter outlet pipe 14 has a mechanism on outside of casing for manually controlling the valve position by hand which will determine amount of water being diverted out of outlet pipe 13 and into diverter outlet pipe 14, manual valve 7 on each small stream or small streams of water 3 near connection to outlet pipe 14 has mechanism on outside for each corresponding manual valve 7 for manually controlling valve position by hand and amount of water thru to each corresponding small stream or streams of water it is on and suction cup 5 attach to bottom outside of casing and suction cup mechanism 8 on outside of casing to manually engage or disengage suction cup 5 by hand to bottom surface of tub or similar area in shallow amount of water high enough to keep above water pump, spray nozzle 4 at end of each small water stream or streams 3 that spray on erogenous area.

Small/micro water pump 2 used to pump water out thru outlet pipe to smaller stream or streams of water 3 that lead to a spray nozzle 4 on each stream and thru diverter outlet pipe 14 depending on manual valve 15 valve position by diverter outlet pipe 14

Smaller stream or streams of water 3 that lead to a spray nozzle 4 on each stream and the stream(s) can be moved by hand to point at erogenous areas and stream(s) can be position stationary to stay focus on the part of erogenous area of the body wanting stimulated by stream(s).

Spray nozzle 4 at end of each smaller stream or streams of water that spray on erogenous area.

Suction cup 5 to hold casing of plastic 1 stationary to bottom surface of tub or an adherable surface

Battery compartment 6 inside casing of plastic 11 that holds a battery to provide power to small/micro water pump 2

Manual valve 7 on each smaller stream or streams of water 3 to control amount of water flow thru to end leading to a spray nozzle 4 on each stream that sprays on erogenous area and has mechanism on outside for manually controlling valve position by hand

Suction cup mechanism 8 use to engage or disengage suction of suction cup 5 manually by hand

Electrical wire 9 leading from plastic casing 11 to plastic casing 1 that will provide the power from battery compartment 6 to small/micro water pump 2 depending on when on/off switch 10 is turned on or off

On/off switch 10 on plastic casing 11 used to turn on and off by hand the small/micro water pump 2 in device

Plastic casing 11 holding on/off switch 10 and battery compartment 6 to hold battery for powering device and electrical line 9 leading from plastic casing 11 on/off switch 10 to plastic casing 1 small/micro water pump 2 that will provide the power from battery compartment 6 to small/micro water pump 2 to turn on or off device

Inlet pipe 12 used to bring in water to small/micro water pump 2

Outlet pipe 13 where water pumps out from small/micro water pump 2 and runs by a manual valve 15 by diverter outlet pipe 14 and then certain amount of water will then continue thru rest of outlet pipe 13 and diverter outlet pipe 14 depending on the manual valve 15 valve position, any water not diverted continues thru the rest of outlet pipe 13 runs by a manual valve 7 on each small stream or streams of water 3 and depending on the manual valve 7 valve position on each corresponding small stream or streams of water 3 control amount of water that flows thru the corresponding stream it is on and then on thru to a spray nozzle 4 at end of each stream

Diverter outlet pipe 14 allows water to be diverted out of outlet pipe 13 and outside of casing by manual valve 15

Manual valve 15 by diverter outlet pipe 14 which its valve position determines amount of water that is diverted from outlet pipe 13 and into diverter outlet pipe 14 and has mechanism on outside for manually controlling valve position by hand

1. A sex toy, comprising:
two casings;
casing 1 consist of inlet pipe for receiving water from a water source leading into a small/micro water pump contain inside; outlet pipe from small/micro water pump where water pumps out from pump; water in outlet pipe then runs by manual valve by diverter outlet pipe; any water diverted by the manual valve by diverter outlet pipe is diverted out of outlet pipe and into diverter outlet pipe; any water in outlet pipe not diverted by manual valve by diverter outlet pipe then runs by thru rest of outlet pipe to a manual valve at beginning of each small stream of water coming off outlet pipe and the manual valve on each small stream of water near outlet pipe will control the amount of water flow from outlet pipe and into each corresponding water stream leading to their corresponding spray nozzle end; electrical wire attach from small/micro water pump in case Ito on/off switch in casing 2 for turning on and off water pump; a suction cup outside bottom surface of casing 1; a suction cup mechanism to engage and disengage suction to surface; spray nozzle at end of each water stream
casing 2 consist of a battery compartment; on/off switch; electrical wire from small/micro water pump in case 1 to on/off switch in casing 2 for turning on and off water pump

2. A sex toy as in claim 1 wherein said small stream or streams of water where the stream(s) can be moved by hand to point at erogenous areas and stream(s) can be position stationary to stay focus on the part of erogenous area of the body wanting stimulated by stream(s); the small stream or streams of water can be positioned to point at erogenous areas of a person in different positions whether lying down, kneeling, squatting or standing; in lying down, kneeling, or squatting position it would be possible for average person with moderate flexibility and dexterity to move the stream(s) by hand around the erogenous area pointed at while being stimulated by stream(s) of water instead of just using a stationary stream(s) position(s) during stimulation; each small stream of water has a spray nozzle at the end of stream where water sprays from; spray nozzle may also be adjustable for different spray effects
